(19) United States
(12) Patent Application Publication
(10) Pub. No.: US 2014/0278592 A1
(43) Pub. Date: Sep. 18, 2014

(54) Apparatus and Method for Seat Management in an Audience Venue

(71) Applicant: Joseph Giampapa, Oviedo, FL (US)

(72) Inventor: Joseph Giampapa, Oviedo, FL (US)

(21) Appl. No.: 13/802,168

(22) Filed: Mar. 13, 2013

(51) Int. Cl. G06Q 10/02; G06Q 20/40

(52) U.S. Cl. CPC G06Q 10/02; G06Q 20/401
USPC 705/5

(57) ABSTRACT

A novel mass audience venue seat is disclosed, which seat can be locked and unlocked by one or more of a variety of security tokens. The seat is designed to prevent ticket holders from ‘cheating down’ into more expensive seats thereby annoying fellow customers. By being electronically connected into a seat management inventory system, moviegoers and sports fans are provided with a legitimate way to upgrade their seat (much like a seat upgrade on a commercial airline), also creating a new revenue stream for venue and stadium owners. The instant mass audience venue seat can be embodied in an item of original equipment manufacture or in a less-costly retrofit kit.

### BACKGROUND OF THE INVENTION

Commercial airlines throughout the world are very good at using a technique they call “yield management” One manifestation of this technique recognizes that there is only so much space available on an airplane, and that some passengers will voluntarily pay a higher price for more space. Accordingly, instead of making the size of seats and the space between rows all the same, they offer a range of seating options; for example, coach, business class and first class. The respective pricing might be on the order of $300 for coach, $400 for business class and $600 for first class. Squeezing out extra revenue from passengers willing to pay a premium for more elbow room constitutes what I will call the “spatial” dimension of yield management.

Another manifestation of the technique recognizes that airline seats are a perishable commodity. Every time a commercial airliner takes to the sky with empty seats, the airline loses the would-be revenue of those empty seats forever. Thus airline executives strive to achieve the highest possible ratio of seats filled to seats available (known in the industry as “load factor”), ideally 100%. Airlines have also been known to “overbook”—that is, book beyond 100% of capacity to account for last minute cancellations or no-shows. In order to achieve high load factors, airline reservation systems offer passengers a long lead-time to sign up for a given flight; for example, 120 days. Those who sign up very early for their flight not only guarantee themselves a seat—passengers who wait until the last minute may find a particular flight to be sold out and left only with the option to fly “stand-by”—but they may get a discount fare [because the airline likewise wants certainty and will entice passengers to fly a particular flight, as opposed to taking another mode of transportation (eg auto, bus or train) or another flight (eg different date, time of day, or a competing carrier)]. During the 120 day booking window, as a specific flight begins to fill up, reservations software will automatically adjust price to demand. Seats set aside for early-booking discounts may disappear and the airline will charge full fare or maybe even a premium for flights in high demand (eg to a city hosting the Super Bowl or a World Series). As the departure date nears, if there are still unsold seats, reservations software may again adjust the fares and offer discounts to entice last minute travelers onto a flight they would not otherwise have selected. Even as the departure time nears, airlines continue their relentless quest to achieve the highest load factor possible. They may accommodate stand-by passengers (for either unsold seats or for already-sold seats wherein the ticket holder has failed to check-in at least 20 minutes prior to departure) or they may “upgrade” the seat of an existing ticket holder (eg business class to first class) in exchange for an upgrade fee, use of frequent flier miles or as part of some kind of paid service plan membership (eg Ambassador Club or Platinum Rewards). Thus, in addition to its spatial dimension, the principle of yield management also has a “temporal” dimension.

Professional sports franchises are not nearly as good at yield management as are airlines. Take major league baseball (“MLB”) for example. MLB stadiums typically have a seating capacity of 50,000—yet MLB attendance averages only 30,000 per game (30,865 to be exact, according to 2012 attendance figures as posted on www.mlb.com), a load factor of only 60%. On the spatial dimension, stadium owners have over the years increasingly recognized that they can differentiate their ticket prices based on proximity to the field of play. Rather than one price “open seating” or “first come, first served,” seating at MLB games typically depends on location. Because of their unobstructed view and closeness to the players, box seats closest to the field (“Field Box”) and behind the dugouts are typically the most expensive. Box seats behind home plate are next most expensive. Box seats “along the baselines”—that is, past the dugouts following the first and third baselines toward the outfield—are next most expensive. Then there are outfield seats, farther away from the action and lower in price. Least desirable—because of their far-away viewing distance and lower comfort level (typically no seat backs)—yet also the lowest in cost, are the bleacher seats. Meanwhile, the farther back a section is from the playing field, the less desirable the seat and the lower the price. Furthermore, with respect to viewing distance, MLB stadiums usually have one or more tiers (eg a “lower deck” or field level, a middle deck or “loge” level and an upper deck). Sitting above field level but below upper deck, seats in loge are priced correspondingly; that is, less expensive than field level but more expensive than upper deck, again getting cheaper the farther back a section is. Of course, nearly every MLB stadium today also has “Luxury Suites”—containing the largest, most comfortable seats, private bathrooms, fancy television screens, heat & air conditioning, et cetera, and the highest price tag. While MLB now utilizes a dozen or so price levels for a 50,000 seat stadium—compared to over two dozen fare classifications on a mere 500 seat commercial airplane—yield management is being practiced at least to some degree in the spatial dimension.

Not so in the temporal dimension. MLB owners are not astute when it comes to time discounting. For many years, the only discount from face value was to so-called “season's ticket” subscribers. These customers received a per-game discount from face but, in exchange, were required to buy a ticket (or worse yet, a 4-ticket box) for every home game (not much of a bargain when the home team is 25 games out of first place by the all-star break). Only in recent years have local MLB marketers begun to offer discount plans for less than a full season's subscription (eg a 20-game plan or a Fri/Sat/Sun package deal). In fact, ubiquitous ticket scalpers are better than MLB owners when it comes to temporal yield management. They have a much better sense of a ticket's worth based on time of day, day of week, weather, team standing, winning streaks, who's pitching, statistical records about to be broken, etc. A scalper will buy tickets in bulk, at the box office, from a ticket broker or even from game-day ticket holders with extra tickets, then hawk them for a premium up to and even beyond first pitch! The profits of illegal ticket scalping come right out of the pockets of MLB owners.

There are further stadium seating practices that cause loss of revenues from the pockets of MLB owners; namely, seat cheaters and dishonest ushers. The seat cheater phenomenon can be observed at any MLB game. Before or at the start of the game, ticket holders are more or less escorted to their seat by an usher. Ushers facilitate the seating process by quickly directing patrons to the proper section, row and seat—saving wandering time, validating seat location (eliminating the need to re-seat improperly located customers) and minimizing disruption to already-seated customers. Some ushers wear mitten-like gloves and wipe off any dirt or liquid (raindrops or spilled beverages) from the stadium seat, for which they will expect a $1-$5 tip. You will recall that a given event will offer a dozen or so ticket price levels. Not all customers will opt to purchase the “best” seat available and pay a premium price; many fans are content to watch a game from a non-premium view for a non-premium price. Interestingly, however, if an MLB owner waited until the third or fourth inning of a game, then compared the number of premium tickets sold per the seating chart from electronic inventory versus a visual check of seats actually occupied, they would find a substantial discrepancy. The discrepancy can be explained by the behavior of non-premium ticket holders “cheating down” into vacant higher-priced seats. The practice is rampant. Ushers do nothing to stop it because they believe they have already performed their function and that the ongoing duty to police seating is “security's job.” Legitimate premium ticket holders, though they may be irritated by the cheaters—who command the same view preferential of the event but who unfairly paid less money—rarely raise a fuss (whether for fear of confrontation, retaliation or some other reason). So, more often than not, seat cheaters get away with their unscrupulous behavior. Ushers, too, sometimes behave dishonestly. Many of the ushers who patrol premium-seating sections are long-time ballclub employees. Based on seniority, they are assigned to a “regular” area. They come to know the season ticket holders, and their schedules, or just keep a careful eye over their designated territory. A knowing fan may quietly pull aside an usher and inquire on the down low about getting a better seat. In exchange for a $10-$20 “tip,” the usher with their aura of officiality—will illegally re-seat their new friend to a premium seat he or she knows will otherwise remain empty. Or the usher may clandestinely solicit the cheap seats to find customers amenable to the ‘free upgrade for a tip’ scam. An usher who sells a half-dozen to a dozen seats per game in this manner can easily double or triple their pay, with little risk and nobody the wiser—except the practice is equivalent to illegally stealing money from their employer.

Thus, the present invention provides an apparatus and method to minimize revenue loss from scalpers and dishonest ushers. The invention also discourages non-premium ticket holders from cheating down into premium seats. And the invention improves the ability of audience venue and professional sports owners to achieve better temporal yield management.

### DESCRIPTION OF THE FIGURES

FIG. 1 is a plan view of a typical stadium seat shown in the upright position.

FIG. 2 is a plan view of a typical stadium seat in the folded-down position.

FIG. 3 is a flowchart of a seating management system of the present invention.

FIG. 4 illustrates a typical ticket used for admission to a professional sporting event.

### DETAILED DESCRIPTION OF THE INVENTION

FIG. 2 is a plan view of the preferred embodiment of the inventive stadium scat shown in the open or un-locked position. Back support member (10) comprises securedly-affixed electromagnetic locks (16a, 16b) located along the right and left borders of the back support, about a third of the way down from the top. Though a pair of electromagnets is shown, the back support member could have just one electromagnet in the middle or, alternatively, one long bar electromagnet across the entire width of the back support. Moreover, the releasable electromagnetic locks could comprise an electromagnetic member with an opposing ferrous member which exhibits attraction for the electromagnetized member. Since sitting support member or “seat bottom” (12) in the typical seat is shorter in length than back support (10), it is desirable that back support magnets (16a, 16b) align properly with securedly-affixed seat bottom magnets (16c, 16d). Seat bottom magnets (16c, 16d) or, alternatively, one centered or one long bar magnet should have reverse polarity capability; that is, they should be capable of attracting back support magnets (16a, 16b) to maintain the stadium seal in the closed or locked position (see FIG. 1) and repelling seat bottom magnets (16a, 16b) to allow the stadium seat to fold down into the open or unlocked position (see FIG. 2). It is also important that regardless of the magnet arrangement used, the strength of the magnetic fields must be strong enough to prevent being pulled apart by typical human force. Back support member (10) and seat bottom (12) are usually separate components, thus a means associating them is needed. In a preferred embodiment, such associating means may comprise one or more rotatable hinges (14a, 14b). There is no reason why the back support member and the seat bottom could not be one integral piece; similarly, the rotatable hinges could be one, long, contoured, rotatable hinge (for example, a piano hinge), or an integral hinge wherein seat back and seat bottom are one continuous piece and the hinge is a thinner more flexible portion of the material. Legs (18a, 18b), if there are any, are securedly-affixed to said stadium seat to provide stability and support. Legs (18a, 18b) are normally bolted to a concrete stadium floor; however, the back support member could also be securedly-affixed to a concrete back wall, in which case the seat legs could be eliminated. With elimination of the stadium seat legs, and with the seat bottoms up and locked, access would be improved and post-event cleanup made faster and more effective. It should be further understood that the present invention will work equally well with a seat having a frame to which both the back support and the seat bottom need not necessarily connected directly to each other. Alternate embodiments should simply allow the seat bottom to swing up to a position more or less parallel to the back support so that the seat is “closed.”

An important part of the inventive apparatus and method herein presented is the controller/reader (20) for activating the electromagnets (i.e. locking or unlocking the seat bottom). Before giving more detail about said controller, it is to be appreciated that many other “lock & key” mechanisms could serve the same purpose as the electromagnetic locks of the preferred embodiment and are intended to be within the scope of the invention. For example, a mechanical locking pins arrangement could be incorporated within the rotatable hinges. Rather than reversible magnetic polarity, the controller would actuate the pins, such that they would retract into the hinge to permit opening or folding down of the seat bottom or, alternatively, keep the pins out to retain the seat bottom in the closed or locked position. Another example would be one or more padlocks, mechanically activated by a key or electrically activated by a push-button or dial-in numerical code, secured between the seat bottom and the seat back (or seat bottom and any other securedly-affixed support structure).

Another embodiment of the present invention is as a retrofit kit. Much like a one- or two-piece “slip cover” for one's favorite living room chair, in this embodiment—rather than having the electromagnets securedly-affixed to, respectively, the back support and the seat bottom—said electromagnets get secured to the slip cover and the one- or two-piece slip cover gets secured to the back support and the seat bottom. This embodiment allows for seat management via lockable stadium seats without having to replace or remove thousands of already-installed, already-secured, already-paid for venue seats.

While the inventive lockable stadium seat is useful as a stand-alone item to prevent lower-priced ticket holders from unfairly cheating down into more expensive seats, the penultimate value of the invention can be seen when said seat is used as part of an overall seating management system, such as that depicted in FIG. 3. Typically, admission to professional sporting events is regulated by electronic ticket machines—whether from the venue's box office, from a specialty retailer like Ticketron, or from an online ticket broker like StubHub. Upon payment of the appropriate fee, the ticket machine issues a ticket (see FIG. 4) with unique location information (e.g. section, row, seat number, date, time) printed on, as well as symbolically coded on, the ticket and ticket stub. Checking in at the entry gate of the event, the ticket holder presents the admission ticket to a ticket taker, who tears the ticket along a perforated line, keeps the body of the ticket and returns the stub to the customer. Today most ticket takers scan tickets with a hand-held bar code scanner, which validates the authenticity of the ticket and stores and/or transmits statistical data back into a centralized seat management database.

By incorporating a bar code scanner or comparable device into premium stadium seats, and by keeping those seats locked until the true ticket holder scans in to unlock their seat bottom, ticket data and meta-data can be sent—preferably via wireless transmission—to a centralized seat management database. By managing seat inventory accurately and in real time, a new revenue generating opportunity is opened for the stadium owner; namely, the opportunity to practice temporal yield management. With cheaters thwarted by seat locks, the stadium owner can target that same cohort and try to entice them into a legitimately-purchased upgrade. By offering unsold and/or unused premium seats at a discount to bleacher and other non-premium seat customers, a certain percentage will be willing to pay a predetermined upgrade fee. The customer may return to the stadium box office, may use an iPhone or Android app, or may consult a roving Sales Representative carrying a hand-held ticket machine and may exchange his or her current ticket, plus the fee, in exchange for a new ticket stub (“uTICKET”™) coded with their new premium seat location information.

It is to be appreciated that the stadium owner can further improve yield management by adopting a “no show” rule such as those practiced by commercial airlines. Airlines simply instituted a rule, as a condition of sale, that if a ticket holder has not reported to the departure gate within some arbitrary time limit (typically 20 minutes before departure), they forfeit their seat. For example, an MLB owner could void the ticket of any customer who has not unlocked his or her scat by the end of the second inning, or some other time limit. The seat would then be released back into inventory in the seat management database and would be available for resale. Via the above-described program, a win-win situation has been created. Fans obtain a heretofore unavailable option—the ability to upgrade their seat at a significant discount. The stadium owner benefits by generating a new stream of revenue—seat upgrade fees—for an otherwise perishable asset. The invention provides the added advantages of decreasing the number of seat cheaters, thwarting ticket scalpers and deterring dishonest ushers.

While the above figures and detailed description illustrate and describe the instant invention, it is to be appreciated that only a preferred embodiment and several alternate embodiments have been presented. They are not meant to be exhaustive of all possible ways to practice the invention and such other possibilities are incorporated hereby as set forth in the below claims.

1. A mass audience venue seat comprising:
a) a back support member;
b) a seat support member associated with said back support member having a closed position when placed relatively parallel to said back support member, and having an open position when placed relatively perpendicular to said back support member so as to allow the patron to sit thereon;
c) a locking mechanism releasably associated with said mass audience seat, having a locked mode keeping the seat support member in the closed position and having a released mode allowing the mass audience seat to be in the open position; and;
d) a controller-reader able to read a patron's payment token and activate the locking mechanism to release the seat support member from the closed position to the open position.

2. The mass audience venue seat of claim 1, wherein the mass audience venue is selected from a sports stadium, a concert hall, a theater, and a racetrack.

3. The mass audience venue seat of claim 1, wherein the locking mechanism comprises at least one electromagnetic lock.

4. The mass audience venue seat of claim 1, wherein the controller-reader comprises at least one bar code scanner.

5. The mass audience venue seat of claim 1, wherein the controller-reader comprises at least one magnetic strip scanner.

6. The mass audience venue seat of claim 1, wherein the controller-reader comprises at least one radio frequency identification scanner.

7. The mass audience venue seat of claim 1, wherein the controller-reader comprises at least one biometric scanner.

8. The mass audience venue seat of claim 1, wherein the patron's payment token comprises an admission ticket.

9. The mass audience venue seat of claim 1, wherein the patron's payment token comprises a credit card.

10. The mass audience venue seat of claim 1, wherein the patron's payment token comprises a debit card.

11. The mass audience venue seat of claim 1, wherein the patron's payment token comprises a prepaid admission card.

12. The mass audience venue seat of claim 1, wherein the controller-reader further comprises communication with a programmable logic control unit programmed to manage data and meta data from a plurality of seats in a mass audience venue.

13. The mass audience venue seat of claim 13, wherein the communication is wireless.

14. A mass audience venue seat retrofit kit comprising:
a) a back support member slip cover;
b) a seat support member slip cover with said back support member having a closed position when placed relatively parallel to said back support member, and having an open position when placed relatively perpendicular to said back support member so as to allow a patron to sit thereon;
c) a locking mechanism releasably associated with said back support member slip cover, having a locked mode keeping the mass audience seat in the closed position and a released mode allowing the mass audience seat to be in the open position; and
d) a controller-reader able to read a patron's payment token activating the locking mechanism to release the mass audience seat from the closed position to the open position so as to permit the patron to sit thereon;
wherein said back support member slip cover is securedly-affixed over said back support member and said seat support member slip cover is securedly-affixed over said seat support member.

15. A seating management system for an audience venue, said system comprising:
a) a plurality of releasably locking seats;
b) code readers associated with said plurality of releasably locking seats;
c) and a programmable controller with said code readers, wherein said controller is programmed to release one or more seats of the plurality responsive to a patrons payment token, said token containing a release code.

16. The seating management system of claim 15, wherein said code readers comprise bar code scanning capability.

17. The seating management system of claim 15, wherein said code readers comprise magnetic strip scanners.

18. The seating management system of claim 15, wherein said code readers comprise radio frequency identification scanners.

19. The seating management system of claim 15, wherein said code readers comprise biometric scanners.

20. A method for managing seats in a mass audience venue, the method comprising:
a) locking one or more of a plurality of seats to prevent seating thereon;
b) unlocking one or more of the plurality responsive to obtaining payment therefor from a patron;
c) communicating locked and unlocked seat status information for individual seats of the plurality, and
d) managing the communicated seat status information in a seat management database.
